(19) United States
(12) Patent Application Publication
(10) Pub. No.: US 2026/0174062 A1
(43) Pub. Date: Jun. 25, 2026

(54) CAT TOY

(71) Applicant: Germaine Harrison, Dallas, TX (US)

(72) Inventor: Germaine Harrison, Dallas, TX (US)

(21) Appl. No.: 18/989,906

(22) Filed: Dec. 20, 2024

(51) Int. Cl. A01K 15/02

(52) U.S. Cl. CPC A01K 15/0257

(57) ABSTRACT

A cat toy includes a core, a first film layer, and a second film layer. The first film layer surrounds and is separate from the core. The first film layer is crumpled to have a plurality of irregular surfaces and folds to form an irregular gap between the first film layer and the core. The first film layer is resiliently collapsible and stiff to produce a sound when temporarily deformed. The second film layer surrounds and is separate from the first film layer. The second film layer is crumpled to have a plurality of irregular surfaces and folds to form an irregular gap between the second film layer and the first film layer. The second film layer is resiliently collapsible and stiff to produce a sound when temporarily deformed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cat toys and more particularly pertains to a new cat toy for providing a sound when crumpled using layers of cellophane or similar film layers of material.

### (2) Description of Related Art Including Information Disclosed Under 37 CFR 1.97 and 1.98

The prior art relates to cat toys that can make sounds and incorporate films that can be crumpled to make the sounds. The prior art, as best understood, does not disclose a cat toy that includes a core, a first film layer, and a second film layer, wherein the first film layer surrounds and is separate from the core and is crumpled to have a plurality of irregular surfaces and folds to form an irregular gap between the first film layer and the core, and wherein the second film layer surrounds and is separate from the first film layer and is crumpled to have a plurality of irregular surfaces and folds to form an irregular gap between the second film layer and the first film layer. Each of the first film layer and the second film layer is resiliently collapsible and stiff to produce a sound when temporarily deformed.

### BRIEF SUMMARY OF THE INVENTION

An embodiment of the disclosure meets the needs presented above in a cat toy generally comprising a core, a first film layer, and a second film layer. The first film layer surrounds and is separate from the core. The first film layer is crumpled to have a plurality of irregular surfaces and folds to form an irregular gap between the first film layer and the core. The first film layer is resiliently collapsible and stiff to produce a sound when temporarily deformed. The second film layer surrounds and is separate from the first film layer. The second film layer is crumpled to have a plurality of irregular surfaces and folds to form an irregular gap between the second film layer and the first film layer. The second film layer is resiliently collapsible and stiff to produce a sound when temporarily deformed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cat toy according to an embodiment of the disclosure.

FIG. 2 is a cross-sectional view of an embodiment of the disclosure.

FIG. 3 is a perspective view of an embodiment of the disclosure in use.

### DETAILED DESCRIPTION OF THE INVENTION

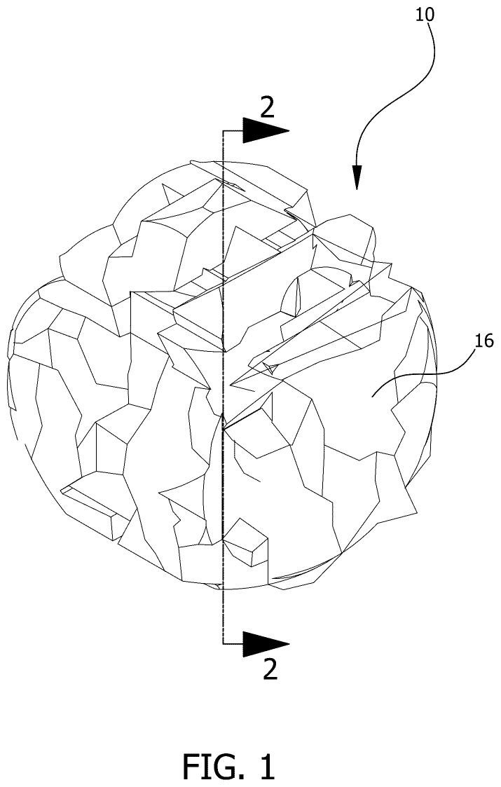

With reference now to the drawings, and in particular to FIGS. 1 through 3 thereof, a new cat toy embodying the principles and concepts of an embodiment of the disclosure and generally designated by the reference numeral 10 will be described.

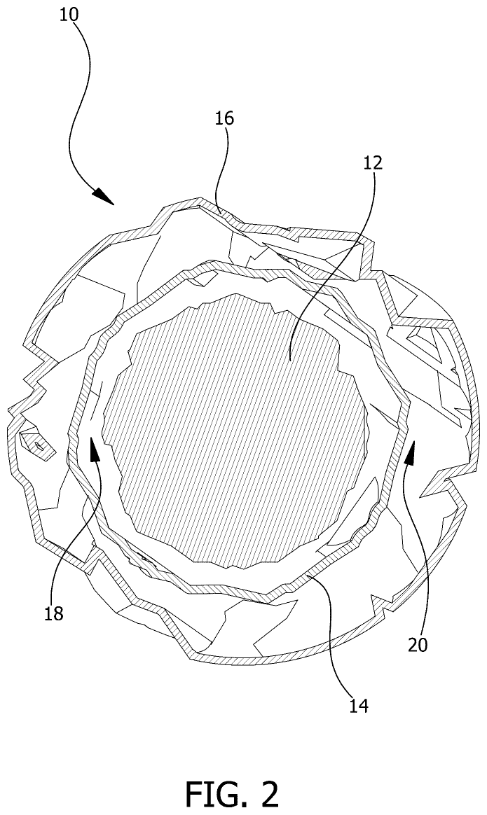

As best illustrated in FIGS. 1 through 3, the cat toy 10 generally comprises a core 12, a first film layer 14, and a second film layer 16, as best seen in FIG. 2. The first film layer 14 surrounds and is separate from the core 12. The first film layer 14 is crumpled to have a plurality of irregular surfaces and folds to form an irregular gap 18 between the first film layer 14 and the core 12. The first film layer 14 is resiliently collapsible and stiff to produce a sound when temporarily deformed. The second film layer 16 surrounds and is separate from the first film layer 14. The second film layer 16 is crumpled to have a plurality of irregular surfaces and folds to form an irregular gap 20 between the second film layer 16 and the first film layer 14. The second film layer 16 is resiliently collapsible and stiff to produce a sound when temporarily deformed.

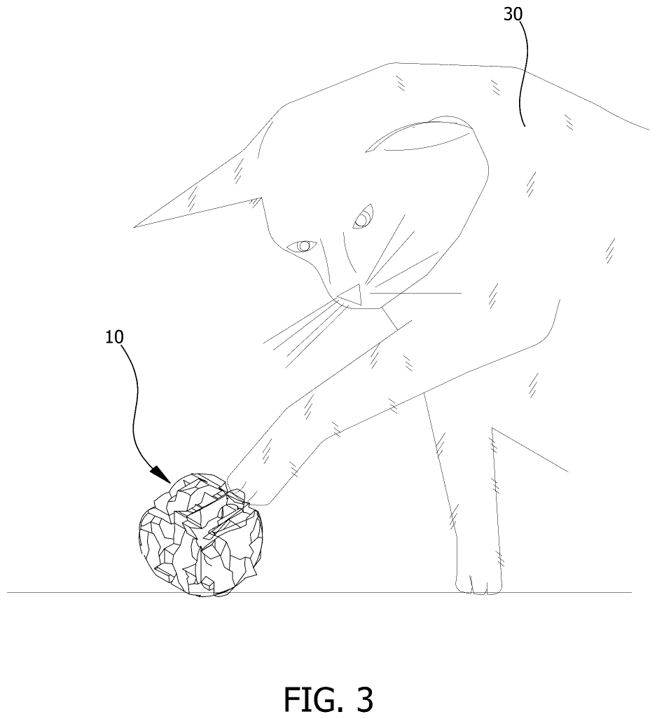

In the exemplary embodiment, the first film layer 14 is cellophane and the second film layer 16 is cellophane. The cellophane is durable and can be crumpled to produce a sound when played with by a cat 30 or other pet, as shown in FIG. 3. The cellophane is also lightweight to allow the cat 30 to pick up the cat toy 10 by mouth, such as during a game of “fetch” with the owner of the cat 30, wherein the owner throws the cat toy 10 and the cat 30 returns the cat toy 10 to the owner. The irregular shape of the first film layer 14 and the second film layer 16 provides the cat 30 with multiple points to bite onto and grab the cat toy 10.

The first film layer 14 is crumpled into a spherical shape, and the second film layer 16 is also crumpled into a spherical shape. The core 12 is a foil layer crumpled into a spherical shape. Other shapes are within the scope of the disclosure, such as an elongated tube or roll, or a square or rectangular prism.

In the exemplary embodiment, the foil layer is aluminum, though other materials could be used, such as plastic or more cellophane.

In one possible embodiment, the second film layer 16 defines a maximum diameter of 10.0 cm, such that the cat toy 10 has a maximum diameter of 10.0 cm. In another possible embodiment, the second film layer 16 defines a maximum diameter in the range of 3.0 cm to 6.0 cm. The cat toy 10 can be essentially any diameter, though the diameter should be small enough for handling and carrying by the cat 30 or similar pet.

In one possible embodiment, the cellophane can be different colors. The core 12 can also be different colors.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cat toy comprising:
a core;
a first film layer enveloping and being separate from said core, said first film layer being crumpled to have a plurality of irregular surfaces and folds to form an irregular gap between said first film layer and said core, said first film layer being resiliently collapsible and stiff to produce a sound when temporarily deformed; and
a second film layer enveloping and being separate from said first film layer, said second film layer being crumpled to have a plurality of irregular surfaces and folds to form an irregular gap between said second film layer and said first film layer, said second film layer being resiliently collapsible and stiff to produce a sound when temporarily deformed.

2. The cat toy of claim 1, wherein said first film layer is cellophane.

3. The cat toy of claim 1, wherein said second film layer is cellophane.

4. The cat toy of claim 1, wherein said first film layer is crumpled into a spherical shape.

5. The cat toy of claim 1, wherein said second film layer is crumpled into a spherical shape.

6. The cat toy of claim 1, wherein said core is a foil layer crumpled into a spherical shape.

7. The cat toy of claim 6, wherein said foil layer is aluminum.

8. The cat toy of claim 1, wherein said second film layer defines a maximum diameter of 10.0 cm.

9. The cat toy of claim 1, wherein said second film layer defines a maximum diameter in the range of 3.0 cm to 6.0 cm.

10. The cat toy of claim 1, wherein said first film layer is cellophane, and said second film layer is cellophane.

11. The cat toy of claim 10, wherein said first film layer is crumpled into a spherical shape, and said second film layer is crumpled into a spherical shape.

12. The cat toy of claim 11, wherein said core is a foil layer crumpled into a spherical shape.

13. The cat toy of claim 12, wherein said foil layer is aluminum.

14. The cat toy of claim 13, wherein said second film layer defines a maximum diameter of 10.0 cm.

15. The cat toy of claim 14, wherein said second film layer defines a maximum diameter in the range of 3.0 cm to 6.0 cm.
